(19) United States
(12) Patent Application Publication
(10) Pub. No.: US 2010/0329408 A1
(43) Pub. Date: Dec. 30, 2010

(54) Systems, Apparatuses and Methods of Gripping, Cutting and Removing Objects

(76) Inventors: Sergey Fiodorov, Mississauga (CA); Radomir Radivojcevic, Toronto (CA); Mark Zimny, Mississauga (CA); Paul Linzender, Willowdale (CA); Narinder Bains, Mississauga (CA); David Morikawa, Burlington (CA)

Correspondence Address: BERESKIN AND PARR LLP/S.E.N.C.R.L., s.r.l., 40 KING STREET WEST, BOX 401, TORONTO, ON, M5H 3Y2, CA

(21) Appl. No.: 12/822,409

(22) Filed: Jun. 24, 2010

Related U.S. Application Data
(60) Provisional application No. 61/219,809, filed on Jun. 24, 2009.

(51) Int. Cl. G21C 19/02

(52) U.S. Cl. 376/260; 976/DIG. 245

(57) ABSTRACT

A system includes a first platform movably mounted to a first rail assembly, a second rail assembly coupled to and supported by the first platform, and a second platform movably mounted to the second rail assembly. At least one articulating arm is coupled to the second platform, and a gripping and cutting apparatus is coupled to and supported by the at least one articulating arm. An apparatus includes first and second gripping mechanisms each configured for selective actuation between positions for gripping and releasing an object, and a cutting mechanism positioned generally between the first and second gripping mechanisms, and configured to cut the object when gripped on either side by the gripping mechanisms. The system and apparatus can be used to remove feeder pipes of a nuclear reactor power plant.

### CROSS-REFERENCE TO RELATED APPLICATION

This application claims priority to U.S. Provisional Application No. 61/219,809 filed on Jun. 24, 2009, the entire contents of which are hereby incorporated herein by reference.

### FIELD

This specification relates to apparatuses and systems for gripping, cutting and removing objects. This specification particularly relates to apparatuses and systems for gripping, cutting and removing piping. This specification also relates to nuclear reactor technology.

### BACKGROUND

A nuclear reactor can contain a plurality of horizontally channels. Fuel bundles placed inside the channels generate heat through a sustained nuclear reaction. Heavy water is passed through each of the channels to transfer the thermal energy to the heat exchanger for steam generation. In some nuclear reactors, the heavy water flows from overhead header pipes through a number of smaller pipes that are referred to as feeder pipes. In some nuclear reactors, feeder pipes can be approximately 4 inches in diameter and range in length from 2 feet to more than 37 feet.

Refurbishment of a nuclear reactor may require the removal and replacement of feeder pipes. Typically, the process of cutting and removing feeder pipes is a manual operation; workers can use saws and manually cut the feeder pipes to manageable lengths and then transport them to long-term waste storage facilities.

### SUMMARY

In an aspect of this specification, a system can comprise: a first rail assembly extending generally parallel to a first direction; a first platform movably mounted to the first rail assembly; a second rail assembly coupled to and supported by the first platform, and extending generally parallel to a second direction; a second platform movably mounted to the second rail assembly; at least one articulating arm coupled to the second platform; and a gripping and cutting apparatus coupled to and supported by the at least one articulating arm.

In another aspect of this specification, an apparatus can comprise: a first gripping mechanism configured for selective actuation between positions for gripping and releasing an object; a second gripping mechanism arranged proximate to the first gripping mechanism, and configured for selective actuation between positions for gripping and releasing the object; and a cutting mechanism positioned generally between the first and second gripping mechanisms, and configured to cut the object when gripped on either side by the gripping mechanisms.

In another aspect of this specification, a method can comprise: providing an apparatus including a first gripping mechanism, a second gripping mechanism arranged proximate to the first gripping mechanism, and a cutting mechanism positioned generally between the first and second gripping mechanisms; moving the apparatus to a first position; actuating the first and second gripping mechanisms to grip an object; operating the cutting mechanism to complete a cut through the object; actuating the second gripping mechanism to release a first severed portion of the object; moving the apparatus to a second position; and actuating the first gripping mechanism to release the other severed portion of the object.

Other aspects and features of the teachings disclosed herein will become apparent, to those ordinarily skilled in the art, upon review of the following description of the specific examples of the specification.

### DRAWINGS

The drawings included herewith are for illustrating various examples of articles, methods, and apparatuses of the present specification and are not intended to limit the scope of what is taught in any way. In the drawings:

FIGS. 1A, 1B and 1C are perspective, top and side views, respectively, of an example of a cutting and removal system.

FIGS. 2A, 2B and 2C are perspective, top and side views, respectively, of another example of a cutting and removal system.

FIGS. 3A, 3B, 3C and 3D are rear perspective, front perspective, side and top views, respectively, of an example of a gripping and cutting apparatus.

FIGS. 4A, 4B, 4C and 4D are rear perspective, front perspective, side and top views, respectively, of another example of a gripping and cutting apparatus.

FIGS. 5A, 5B and 5C are detailed views of FIG. 4A.

FIGS. 6A and 6B are detailed views of FIG. 4B.

### DESCRIPTION OF VARIOUS EMBODIMENTS

Various apparatuses or processes will be described below to provide an example of an embodiment of each claimed invention. No embodiment described below limits any claimed invention and any claimed invention may cover processes or apparatuses that are not described below. The claimed inventions are not limited to apparatuses or processes having all of the features of any one apparatus or process described below or to features common to multiple or all of the apparatuses described below. It is possible that an apparatus or process described below is not an embodiment of any claimed invention. The applicants, inventors or owners reserve all rights that they may have in any invention disclosed in an apparatus or process described below that is not claimed in this document, for example the right to claim such an invention in a continuing application and do not intend to abandon, disclaim or dedicate to the public any such invention by its disclosure in this document.

Manual removal of feeder pipes in a nuclear reactor can cause contamination of the reactor vault through, for example, trillium release from the header pipes and/or particle dispersion from the chips generated by the cutting operation. Contamination may pose a health risk to the workers inside the vault, and can cause the contamination equipment that enters the vault during refurbishment. Decontamination may require considerable time and energy, and the storage of radioactive waste. The teachings herein relate to systems and apparatuses for gripping, cutting and removing feeder pipes from a nuclear reactor with a view to reducing or eliminating contamination of the reactor vault and exposure to trillium and radioactive particle release.

In the drawings and in this description, like reference numerals will be used to indicate like elements, functions or features as between the drawings and the described examples.

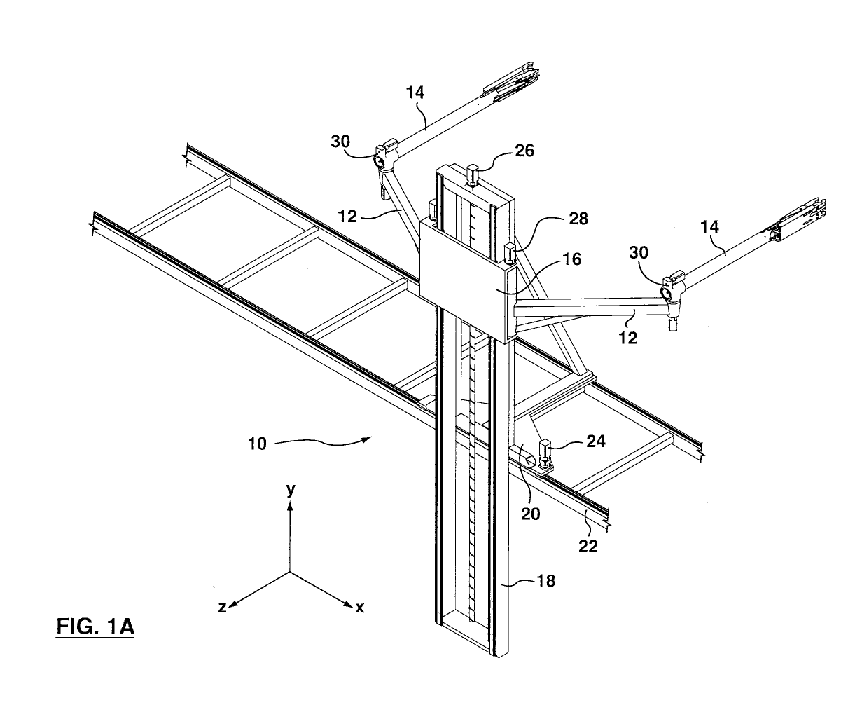

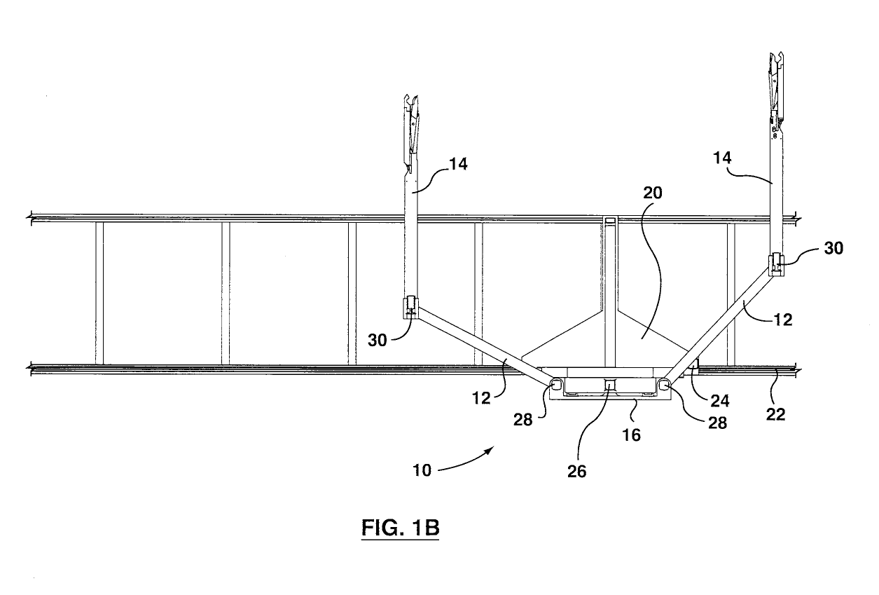

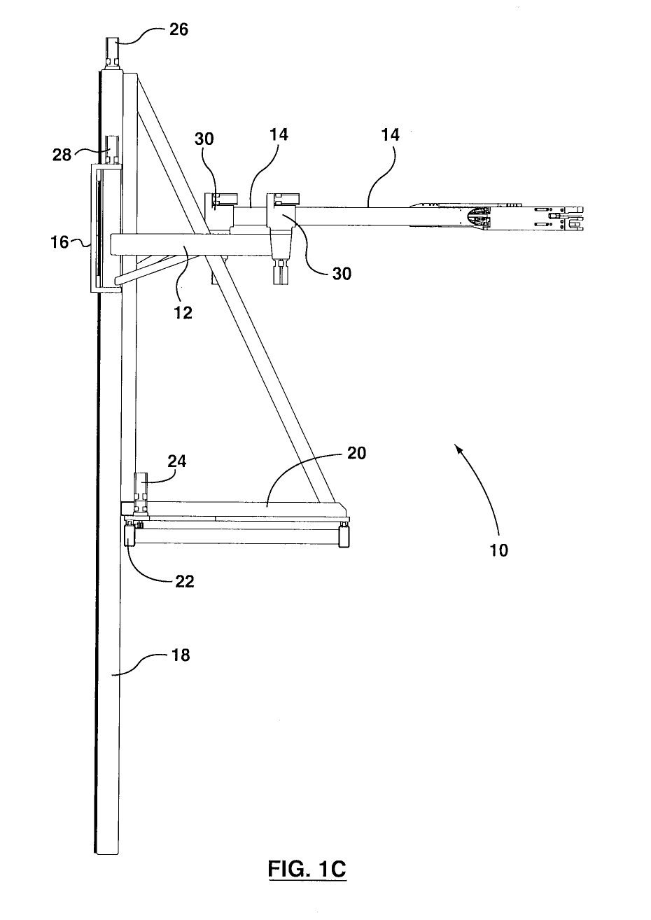

Referring to FIGS. 1A, 1B and 1C, a system shown generally at 10 allows for operators to cut and remove manageable sections of objects, for example but not limited to, feeder pipes of a nuclear reactor. The system 10 includes a moveable base that supports two articulating arms 12. Each arm 12 can be coupled with a gripping and cutting apparatus 14, as described in further detail below.

For a nuclear reactor face area, a coordinate system can be used to generally describe the horizontal axis as a first axis or x-axis, the vertical axis as a second axis or y-axis, and the direction perpendicular to the reactor face as a third axis or z-axis.

The system 10 can include a platform 16 mounted on a y-axis rail assembly 18 and configured to move along the y-axis. The system can further include a platform 20 mounted on an x-axis rail assembly 22 and configured to move along the x-axis. The y-axis rail assembly 18 can be coupled to and supported by the platform 20. Each of the rail assemblies 18, 22 can include linear guide rails that support the platforms 16, 20, respectively, through a set of linear bearings.

A drive mechanism 24 can be provided to selectively move the platform 20 along the rail assembly 22. In some examples, the drive mechanism 24 can include a servo motor configured to drive a pinion that engages a rack provided along the rail assembly 22. The drive mechanism 24 can be remotely operated. Similarly, a drive mechanism 26 can be provided to selectively move the platform 16 along the rail assembly 18. In some examples, the drive mechanism 26 can include a servo motor configured to actuate a ball screw mechanism. The drive mechanism 26 can be remotely operated.

The platform 16 is coupled to and supports the arms 12. The arms 12 are configured to selectively position the apparatuses 14. The use of two arms 12 and apparatus 14 can allow the system 10 to reach feeder pipes that are horizontally beyond the end of the platform and thus the end of the sliding platform 20 x-axis motion, at either end thereof. Each arm 12 can be coupled to the platform 16 with a first yaw joint 28, enabling movement about the y-axis. A second yaw joint 30 can couple the arm 12 with its respective apparatus 14. The joints 28, 30 allow the system 10 to reach a relatively wide area and still remain in the x-z plane. In some examples, the joints 28, 30 can be servo actuated for precise positioning. Remote operation of the joints 28, 30 can be achieved through use of a PLC based control system that determines correct joint configurations for x- and y-axis motion.

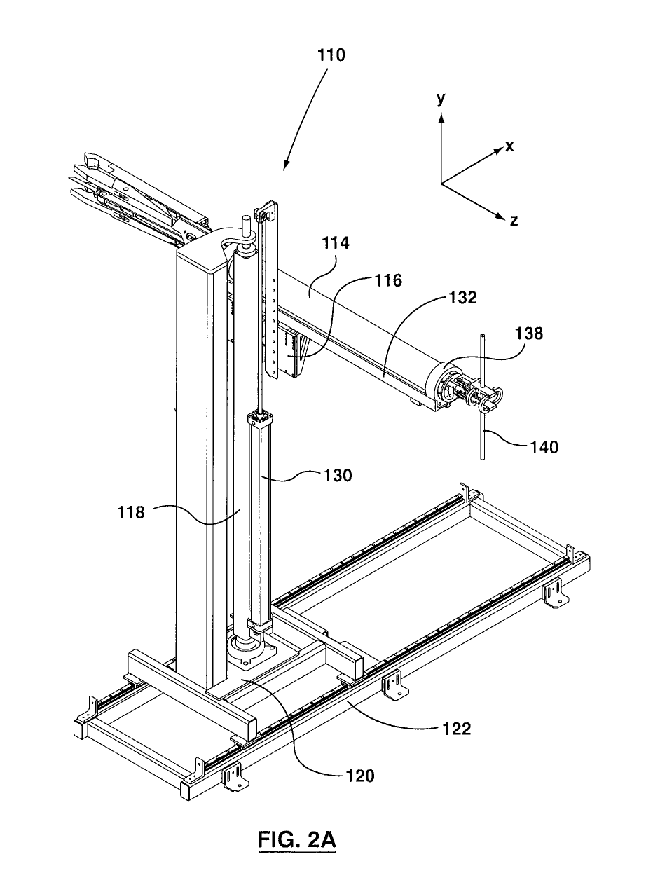

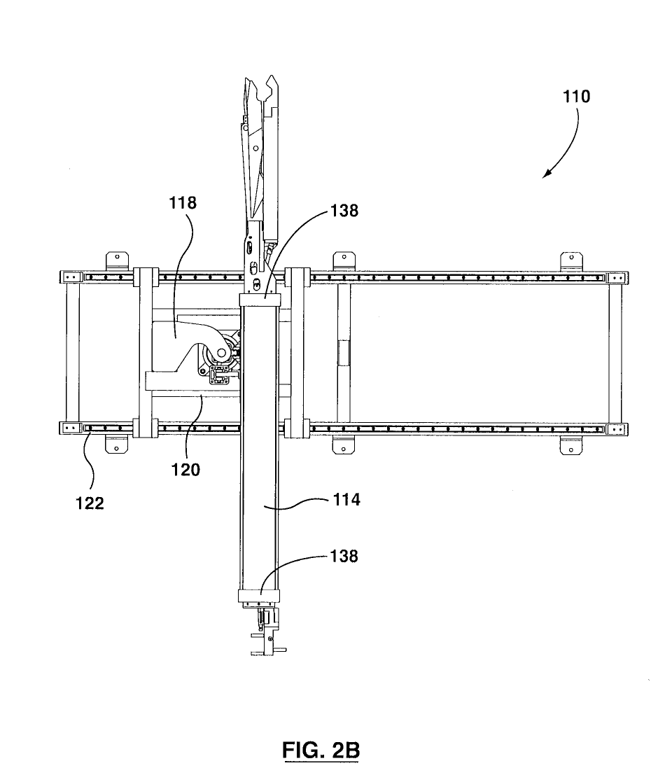

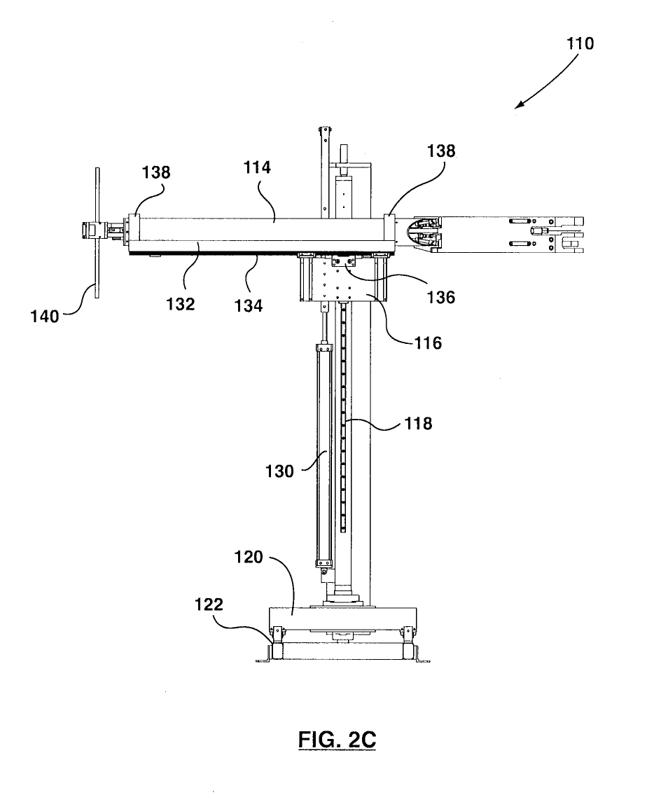

Referring to FIGS. 2A, 2B and 2C, another system shown generally at 110 allows for operators to cut and remove manageable sections of objects, for example but not limited to, feeder pipes. The system 110 includes a moveable base that supports a gripping and cutting apparatus 114, as described in further detail below. The system 110 is similar to the system 10, but system 110 can be at least partially manually controlled.

The system 110 can include a platform 116 mounted on a y-axis rail assembly 118 and configured to move along the y-axis. The system can further include a platform 120 mounted on an x-axis rail assembly 122 and configured to move along the x-axis. The y-axis rail assembly 118 can be coupled to and supported by the platform 120. Each of the rail assemblies 118, 122 can include linear guide rails that support the platforms 116, 120, respectively, through a set of linear bearings. The platform 120 can be manually movable along the rail assembly 122.

A supporting mechanism 130 can be provided, mounted to the platform 120 and coupled to either the platform 116 or the apparatus 114, to support the apparatus 114 and selectively raise or lower the apparatus 114. In some examples, the supporting mechanism 130 can be a pneumatic or hydraulic cylinder, actuated by the operator using a switch or other control means.

The apparatus 114 is coupled to the platform 116 by a carriage member 132. The carriage member 132 supports the apparatus 114 and enables linear motion along the z-axis as well as a rolling motion about the z-axis. A linear rail 134 mounted on a lower surface of the carriage member 132 can slide within a bearing block 136 mounted on the platform 116, providing translational movement along the z-axis. The bearing block 136 can generally provide a rigid connection supporting the weight of the apparatus 114 and resisting rotational movement. Rotation about the z-axis (i.e. roll), enabling alignment of the end of the apparatus 114, can be achieved using bushings 138 mounted on opposite ends of the carriage member 132. The bushings 138 can be shaped generally as section of a hollow cylinder, and can firmly hold the cylindrical body of the apparatus 114 while allowing it to roll about the z-axis. In some examples, the bushings 138 can be formed of DELRIN™. One or more handles 140 can be provided at a rear end of the apparatus 114, which can provide torque leverage for manually rotating the apparatus 114 as well as moving it along the x- and z-axes.

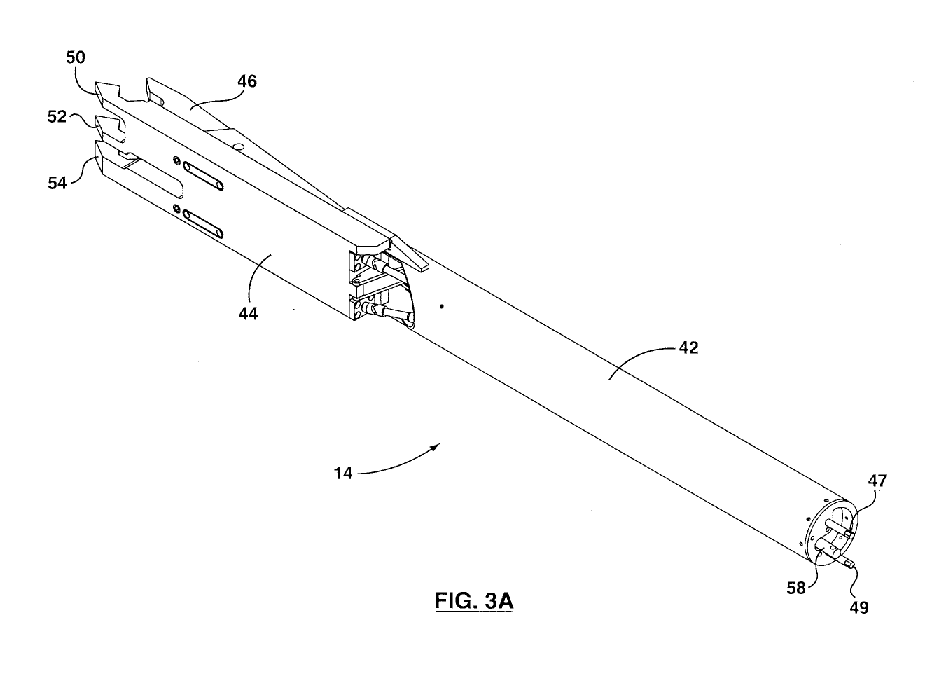

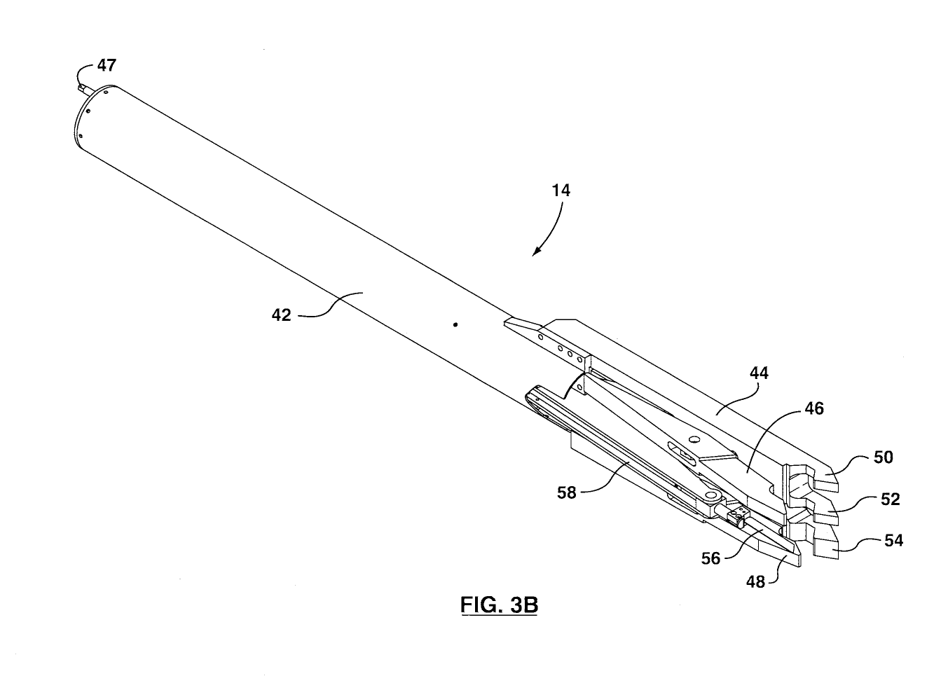

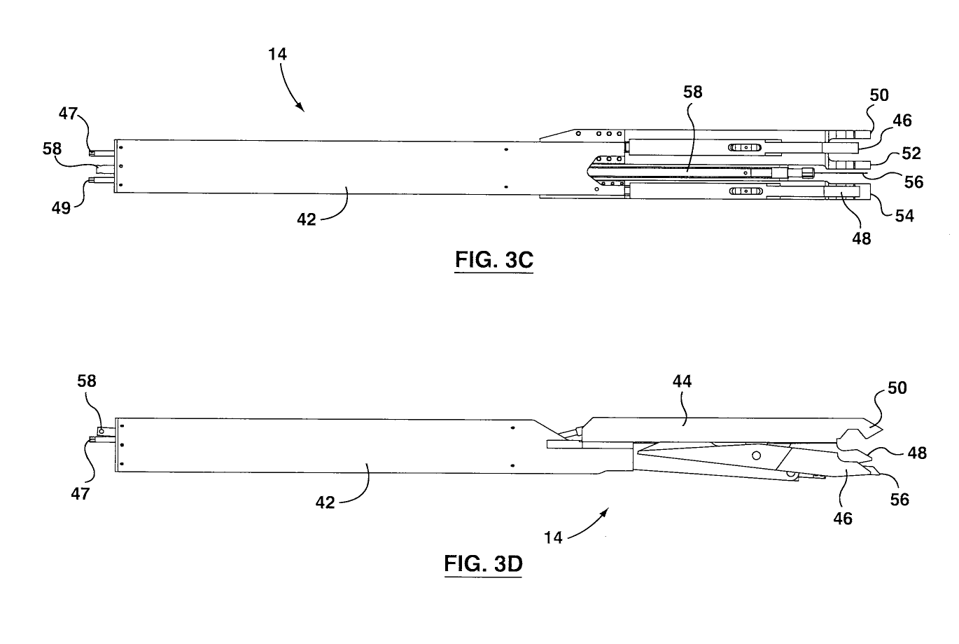

FIGS. 3A, 3B, 3C and 3D show further details of the apparatus 14 of system 10. The apparatus 14 is designed to grip and support an object, for example but not limited to a feeder pipe, to make a cut, and to allow removal of the severed piece.

The apparatus 14 can include a generally cylindrical body 42 that defines a longitudinal axis. A stationary jaw member 44 is rigidly coupled to the body 42 extending longitudinally beyond a front end thereof. First and second clamping jaw members 46, 48 are coupled to the body 42 and also extend longitudinally beyond the first end. The first and second clamping jaw members 46, 48 and are each configured to pivot, independently, relative to the stationary jaw member 44. The clamping jaw members 46, 48 can be moved towards and away from the stationary jaw member 44 to respectively grip or release an object. Actuation of the clamping jaw members 46, 48 can be controlled through use of the control rods 47, 49, which are described below.

The stationary jaw member 44 includes first, second and third fingers 50, 52, 54 extending generally in the longitudinal direction away from the body 42. The first and second fingers 50, 52 of the stationary jaw member 44 are positioned in generally opposing alignment with the first clamping jaw member 46, defining a first gripping mechanism with three points of contact. The third finger 54 of the stationary jaw member 44 is positioned in generally opposing alignment with the second clamping jaw member 48, defining a second gripping mechanism with two points of contact.

A cutting mechanism in the form of a saw blade 56 is positioned generally between the first and second clamping jaw members 46, 48. The saw blade 56 can be reciprocating, and driven by a connecting shaft 58, which transfers reciprocating motion to the saw blade 56 from a motor (not shown). In some examples, reciprocation of the saw blade 56 can be achieved through an AC motor. The connecting shaft 58 can be a hollow, relatively thin walled shaft, thereby minimizing weight and inertia of the connecting shaft 58 and reducing the forces on the motor. The connecting shaft 58 can be mounted inside the body 42, and can be supported by a number of guides (formed, for example, of DELRIN™) to prevent the connecting shaft 58 from buckling. The saw blade 56 can be progressively moved using a servo or hydraulic actuator (not shown), as described below.

In use, an object, such as a pipe, can be held firmly by actuating both the first and second clamping jaw members 46, 48 to bear towards the stationary jaw member 44, thus gripping the object between the fingers 50, 52, 54 and the stationary jaw member 44. The reciprocating saw blade 56 can be moved progressively through the object. Once a complete cut has been performed, the second clamping jaw member 48 can be released relative to the stationary jaw member 44. The section of the object that remains gripped between the first clamping jaw member 46 and the stationary jaw member 44 can then be transported, for example, to a shielded waste container.

Features of the apparatus 14 can be further understood with reference to the description of the apparatus 114, provided below.

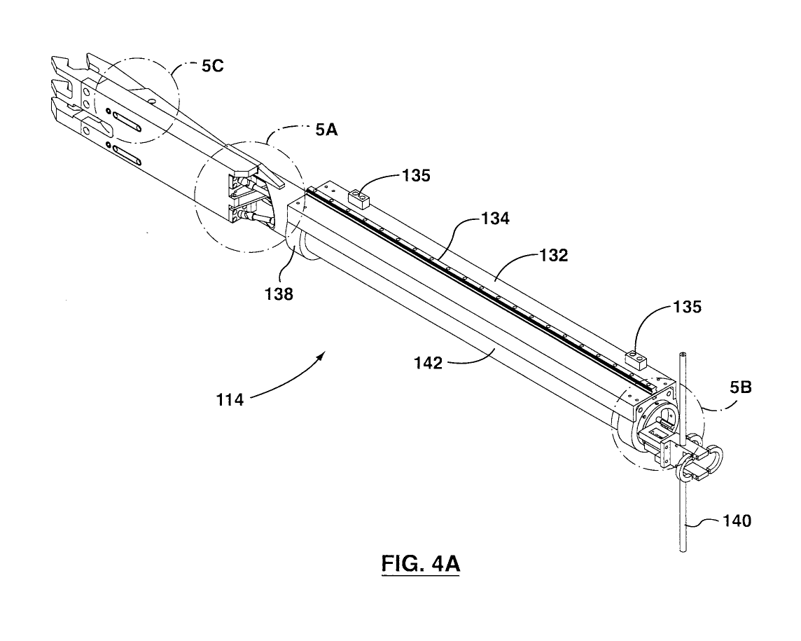

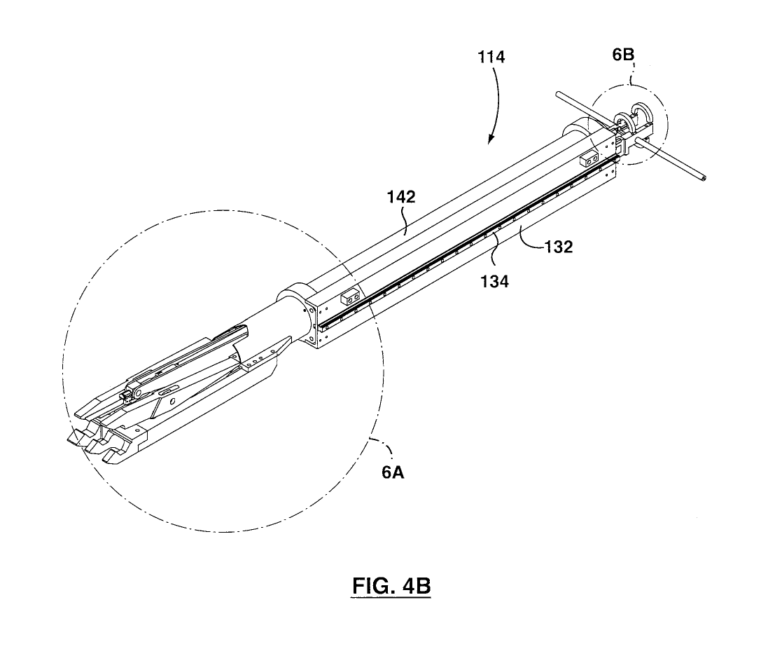

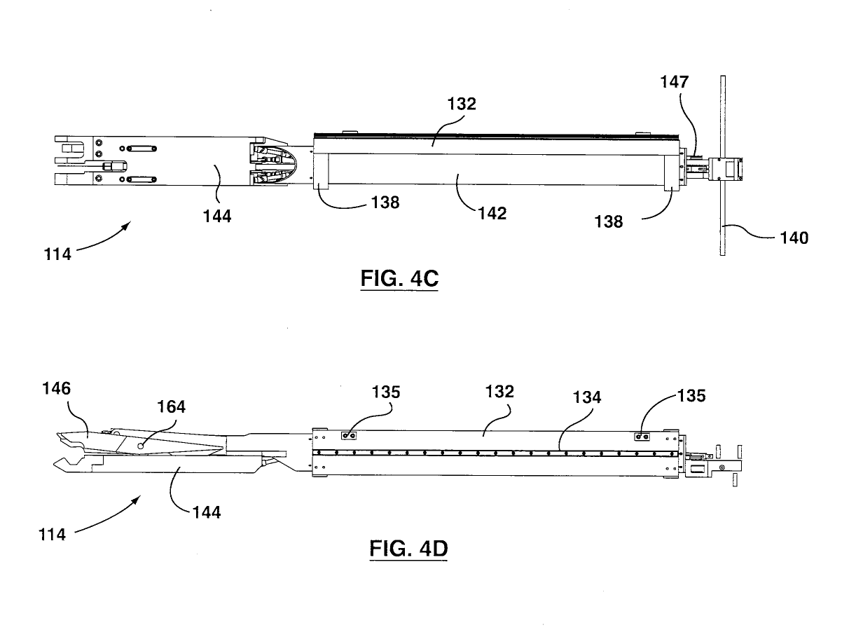

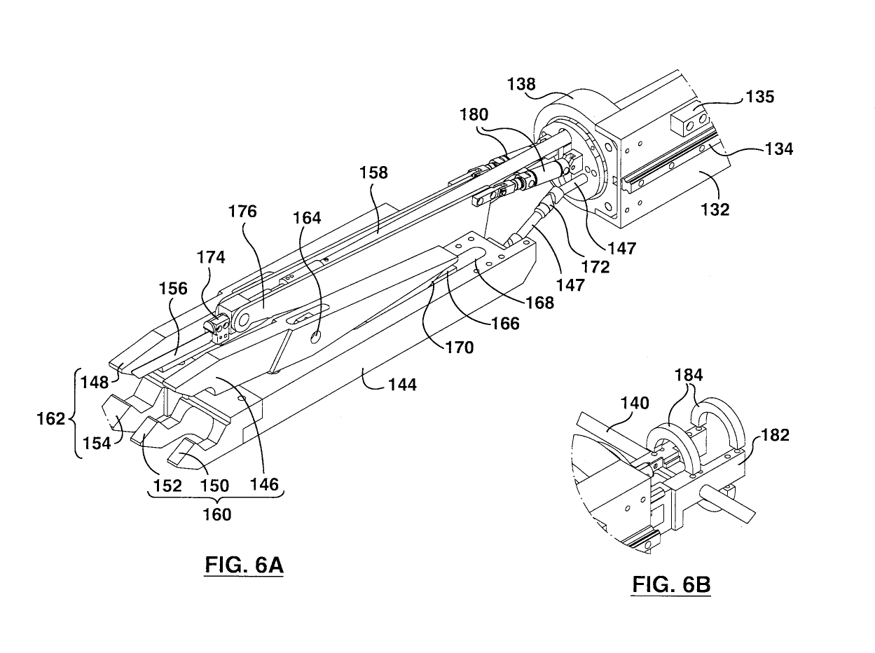

FIGS. 4A, 4B, 4C, 4D, 5A, 5B, 5C, 6A and 6B show further details of the apparatus 114 of system 110. As described above, the carriage member 132 supports the apparatus 114, and the linear rail 134 mounted on the lower surface of the carriage member 132 can slide within bearing block 136 mounted on the platform 116 (see FIG. 2C). The lower surface of the carriage member 132 can further include stops 135 to prevent the apparatus 114 from being released from the bearing block 136.

As described with reference to the apparatus 14, the apparatus 114 includes first and second fingers 150, 152 of a stationary jaw member 144 at the front end of the body 142. The first and second fingers 150, 152 are positioned in generally opposing alignment with a first clamping jaw member 146, and define a first gripping mechanism 160 with three points of contact. A third finger 154 of the stationary jaw member 144 is positioned in generally opposing alignment with a second clamping jaw member 148, and define a second gripping mechanism 162 with two points of contact. A reciprocating saw blade 156 is positioned generally between the first and second clamping jaw members 146, 148.

The first gripping mechanism 160 has three points of contact to securely hold the severed section of the object for removal, whereas the second gripping mechanism 162 has two points of contact to provide rigid connection with the object during cutting. After cutting is complete, the second gripping mechanism 162 can be released from the severed section, whereas the first gripping mechanism 160 remains engaged with the severed object. The apparatus 114 can then be moved to dispose of the severed section at a desired location.

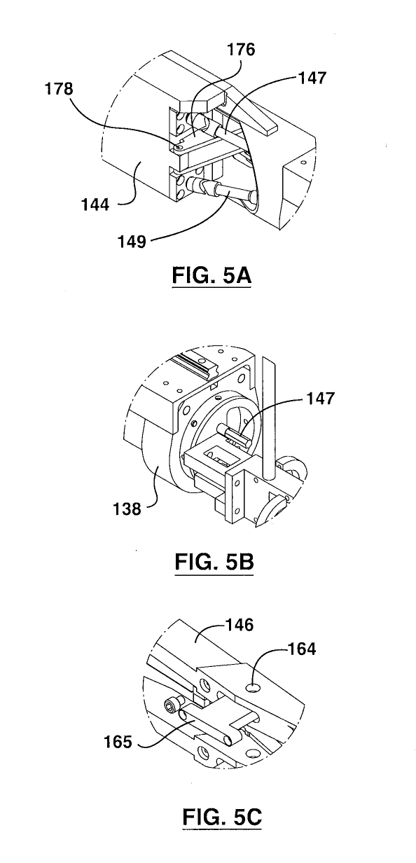

The clamping jaw members 146, 148 can be fixed to the stationary jaw member 144 with a pivot connection 164, which can include an axial block 165 (see FIG. 5C) for each of the clamping jaw members 146, 148.

A wedge block 166 is provided in a groove 168 in the stationary jaw member 144. The wedge block 166 is moveable in the groove 168 generally in the longitudinal direction, towards and away from the body 142. The wedge block 166 is configured to bear against a cam surface 170 at the back of the clamping jaw member 146 so that forward movement of the wedge block 166 away from the body 166 urges the front portion of the first clamping jaw member 146 against the stationary clamping member 144. Actuation of the wedge block 166 can be achieved through a screw mechanism (not shown) that is turned manually by a control rod 147. Rotating the screw mechanism by the control rod 147 moves the wedge block 166, which has a threaded surface on the inside, longitudinally. Access to the control rod 147 can be provided at the rear end of the body 142, and can be manipulated with a ratchet (not shown). The control rod 147 can consist of several sections, the sections linked together with extensions 172.

The screw mechanism provides a mechanical advantage to allow an operator to manually exert force on the gripping mechanism 160. The second gripping mechanism 162 can have a similar wedge and screw configuration, driven by a control rod 149.

The first and second clamping jaw members 146, 148 can be biased away from the stationary jaw member 144, for example, using springs (not shown). If the first and second clamping jaw members 146, 148 are biased away from the stationary jaw member 144, movement of the wedge blocks in a direction towards the body 142 will cause the clamping jaw members 146, 148 to move away from the stationary jaw member 144, towards an open position.

The saw blade 156 is positioned generally between the gripping mechanisms 160, 162 in order to minimize vibrations and forces exerted on the objects and anything connected to the objects. The saw blade 156 can be held in position by a holder block 174, which can be configured to accommodate various shapes and sizes of blades.

The saw arm member 176 supports the holder block 174 but allows movement so that reciprocating motion can be transferred from the connecting shaft 158 to the saw blade 156. The saw arm member 176 can pivot about the connection point 178 to provide a range of motion for the saw blade 156. One or more air cylinders 180 can be connected to the saw arm member 176 to provide constant and controlled force to the saw blade 156 during cutting.

A means of mounting the saw motor (not shown) can be provided at the rear end of the body 142, and which can include a base 182 and one or more clamping collars 184.

A vacuum nozzle (not shown) can be implemented with the apparatus 114 to reduce the release of contamination from the feeder pipe being cut.

Although the apparatuses 14, 114 and shown and described to including a reciprocating saw blade 56, 156, other cutting mechanisms are possible. Circular saws, chipless pipe cutters, flame cutters and plasma cutters are contemplated and may be compatible with the teachings herein, depending on the particular cutting application.

The use of a reciprocating saw is relatively compact and can provide relatively low cycle times. However, reciprocating blades are typically not designed for continuous use, and wear can be a concern. Selection of a suitable blade depends on the object to be cut. For feeder pipe applications, a saw blade with carbide inserts may be of acceptable durability.

Although this specification describes systems and apparatuses for gripping, cutting and removing piping particularly in the context of a nuclear reactor, it should be appreciated that other applications of the teachings herein are contemplated.

While the above description provides examples of one or more processes or apparatuses, it will be appreciated that other processes or apparatuses may be within the scope of the accompanying claims.

We claim:

1. A system, comprising:
a first rail assembly extending generally parallel to a first direction;
a first platform movably mounted to the first rail assembly;
a second rail assembly coupled to and supported by the first platform, and extending generally parallel to a second direction;
a second platform movably mounted to the second rail assembly;
at least one articulating arm coupled to the second platform; and
a gripping and cutting apparatus coupled to and supported by the at least one articulating arm.

2. The system of claim 1, wherein the at least one articulating arm is pivotably coupled to the second platform at a first yaw joint.

3. The system of claim 2, wherein the at least one articulating arm is selectively pivotable about an axis that is generally parallel to the second direction.

4. The system of claim 3, wherein the gripping and cutting apparatus is pivotably coupled to the at least one articulating arm at a second yaw joint.

5. The system of claim 4, wherein the gripping and cutting apparatus is selectively pivotable about an axis that is generally parallel to the second direction.

6. The system of claim 5, comprising a first drive mechanism configured to selectively move the first platform along the first rail assembly.

7. The system of claim 6, comprising a second drive mechanism configured to selectively move the second platform along the second rail assembly.

8. The system of claim 7, wherein the at least one articulating arm comprises first and second articulating arms arranged on generally opposing sides of the second platform, and spaced apart from one another in the first direction.

9. The system of claim 1, wherein the gripping and cutting apparatus comprises:
a first gripping mechanism configured for selective actuation between positions for gripping and releasing an object;
a second gripping mechanism arranged proximate to the first gripping mechanism, and configured for selective actuation between positions for gripping and releasing the object; and
a cutting mechanism positioned generally between the first and second gripping mechanisms, and configured to cut the object when gripped on either side by the gripping mechanisms.

10. An apparatus, comprising:
a first gripping mechanism configured for selective actuation between positions for gripping and releasing an object;
a second gripping mechanism arranged proximate to the first gripping mechanism, and configured for selective actuation between positions for gripping and releasing the object; and
a cutting mechanism positioned generally between the first and second gripping mechanisms, and configured to cut the object when gripped on either side by the gripping mechanisms.

11. The apparatus of claim 10, wherein the first gripping mechanism comprises a first clamping jaw member configured to pivot relative to a stationary jaw member.

12. The apparatus of claim 11, wherein the stationary jaw member comprises first and second fingers positioned in generally opposing alignment with the first clamping jaw member, defining three points of contact for gripping the object.

13. The apparatus of claim 12, wherein the second gripping mechanism comprises a second clamping jaw member configured to pivot relative to the stationary jaw member.

14. The apparatus of claim 13, wherein the stationary jaw member comprises a third finger positioned in generally opposing alignment with the second clamping jaw member, defining two points of contact for gripping the object.

15. The apparatus of claim 14, comprising a wedge block moveably mounted relative to the stationary jaw member, the wedge block configured to bear against a cam surface of at least one of the first and second clamping jaw members so that forward movement of the wedge block urges a front portion of the at least one of the first and second clamping jaw members against the stationary jaw member.

16. The apparatus of claim 15, wherein the wedge block is actuated by a control rod, in which rotational movement of the control rod causes corresponding translational movement of the wedge block.

17. The apparatus of claim 16, wherein the first and second clamping jaw members are biased away from the stationary jaw member.

18. The apparatus of claim 14, wherein the cutting mechanism comprises a reciprocating saw blade positioned generally between the first and second clamping jaw members.

19. A method, comprising:
providing an apparatus including a first gripping mechanism, a second gripping mechanism arranged proximate to the first gripping mechanism, and a cutting mechanism positioned generally between the first and second gripping mechanisms;
moving the apparatus to a first position;
actuating the first and second gripping mechanisms to grip an object;
operating the cutting mechanism to complete a cut through the object;
actuating the second gripping mechanism to release a first severed portion of the object;
moving the apparatus to a second position; and
actuating the first gripping mechanism to release the other severed portion of the object.

20. The method of claim 19, wherein the objects are feeder pipes of a nuclear reactor power plant.
